(19) United States
(12) Patent Application Publication
(10) Pub. No.: US 2016/0369785 A1
(43) Pub. Date: Dec. 22, 2016

(54) SYSTEM AND METHOD FOR CONVERTING GRAVITATIONAL ENERGY INTO ROTATIONAL ENERGY AND MOVEMENTS

(71) Applicant: Areg Azizians, Tehran (IR)

(72) Inventor: Areg Azizians, Tehran (IR)

(21) Appl. No.: 15/251,724

(22) Filed: Aug. 30, 2016

Related U.S. Application Data
(60) Provisional application No. 62/301,455, filed on Feb. 29, 2016.

(51) Int. Cl. F04B 9/06; F04B 1/04; F04B 43/08; F03G 3/08

(52) U.S. Cl. CPC F04B 9/06; F03G 3/08; F04B 1/04; F04B 43/086; F05B 2260/421; F05B 2260/40

(57) ABSTRACT

The embodiments herein provide a system and method to convert gravity into continuous rotational motion of a wheel through non-compressible liquid. The system comprises a wheel. Several cylinders and pistons are arranged and equally spaced on the wheel. The cylinders arranged diagonally opposite to each other are connected through a pipe to provide a pathway for the non-compressible fluid. A folding bag is provided in each cylinder and filled with the non-compressible fluid. The folding bags arranged diagonally opposite to each other are connected through connecting pipes. The non-compressible liquid flows into the folding bags based on the motion of the wheel. Each folding bag expands and folds depending on the amount of fluid in the folding bag. The fluid motion maintains the imbalance of the wheel's weight and the wheel sustains the rotational motion.

### BACKGROUND

Technical Field

The embodiments herein are generally related to a fly wheel device. The embodiments herein are particularly related to a flywheel converter for energy. The embodiments herein are more particularly related to a system and a method for converting gravitational energy into a rotational energy resulting in a continuous rotational movement of a wheel. The embodiments herein are especially related to a system and method for converting gravity into continuous rotational motion of a wheel through incompressible liquids.

Description of the Related Art

The need to satisfy the increasing energy demand of an increasing human population is one of the major concerns of technologists worldwide. Due to the sustainable nature and attractive return-on-investment, renewable sources of energy gains a more importance. Apart from solar, wind, geothermal and hydroelectric power generation techniques, the use of Earth's gravitational force to produce energy and convert the gravitational energy into useful work is a very sustainable method. The conversion of gravitational force to work is achieved through the use of flywheel based rotational motion devices.

The currently available rotational wheel devices for performing any work need an external source of energy to sustain the motion of the wheel. However, an imbalance in the weight of the wheel is maintained through appropriate designing of the wheel and using sinkers such that the wheel sustains continuous motion in order to achieve stability. But the use of solid sinkers introduces friction in the system and the friction affects the output of the device. There is a need for developing a device to convert renewable energy into rotational energy and movements with minimum friction. There is also a need for such systems to be sustainable and easily implementable.

Hence, there is a need for a system and method for converting gravitational energy into rotational energy and movements with minimum friction. Further there is a need for a system and method for converting gravity into continuous rotational motion of a wheel through incompressible liquids.

The abovementioned shortcomings, disadvantages and problems are addressed herein and which will be understood by reading and studying the following specification.

### OBJECT OF THE EMBODIMENTS HEREIN

The primary object of the embodiments herein is to provide a system and a method to convert gravity into continuous rotational motion of a wheel.

Another object of the embodiments herein is to provide a system and method to convert gravitational force/energy into continuous rotational energy and movements of a wheel through incompressible liquids.

Yet another object of the embodiments herein is to provide a system and method to enable flow of incompressible liquids in a wheel so that the weight distribution of the wheel is suitably changed to achieve a continuous motion of the wheel.

Yet another object of the embodiments herein is to provide a system and method to enable flow of incompressible liquids in an upward direction in a wheel so that the weight distribution of the wheel is suitable changed to sustain a continuous motion.

Yet another object of the embodiments herein is to provide an arrangement of a plurality of cylinders and pistons to enable a step-by-step change in the weight distribution of a wheel.

Yet another object of the embodiments herein is to provide an arrangement of a plurality of cylinders and pistons with minimum friction between the parts so that an output achieved is better than that of the conventional systems.

Yet another object of the embodiments herein is to provide a folding bag in each of the cylinders to act as the container for the incompressible fluid.

Yet another object of the embodiments herein is to provide connection pipes from a folding bag to another folding bag situated diagonally opposite in the wheel to enable the motion of fluid from one folding bag to another.

These and other objects and advantages of the embodiments herein will become readily apparent from the following summary and the detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings.

The various embodiments herein provide a system and a method to convert gravitational energy into continuous rotational energy and movement of a wheel through incompressible liquids.

According to an embodiment herein, a system for converting gravity to a continuous rotational motion in a wheel is provided. The system comprises a wheel provided with a wheel frame. The wheel is divided into two semi-circular parts. The wheel is designed such that a weight of the wheel is not divided symmetrically between the two semicircular parts. A plurality of cylinders and pistons are provided on the wheel frame. The plurality of cylinders and pistons are arranged and equally spaced on the wheel frame. Each piston is connected to a guiding path. A folding bag is provided on each cylinder in the plurality of cylinders. Each folding bag is filled with a non-compressible fluid. Each folding bag comprises bellows to enable an expansion and contraction of the folding bag. Each folding bag is connected to the piston in the cylinder. A plurality of connecting pipes or hoses are arranged for providing a pathway for a flow of non-compressible fluid between the folding bags arranged diagonally opposite to each other. Each one of the plurality connecting pipes or hoses is connected between the two cylinders that are arranged mutually opposite to each other on the wheel frame to provide a pathway for a movement of the non-compressible fluid. A chassis is provided for supporting the wheel. The wheel is mounted on the chassis through a ball bearing mechanism. The plurality of pistons are connected to the chassis through a piston path reader. A stationary cap is arranged outside the wheel frame and coupled to the chassis to hold the wheel in place. An axle is passed through a rotational axis of the wheel. The axle is coupled to the chassis and the stationary cap. A energy transfer mechanism is coupled to the axle to transfer an output rotational energy. The energy transfer mechanism is a pulley. The non-compressible fluid in the plurality of cylinders provided in one semicircular part of the wheel is emptied by the movement of the pistons and the non-compressible fluid is transferred to the plurality of cylinders in the other semicircular part of the wheel thereby generating an imbalance in weight of the two semicircular parts of the wheel to make the wheel to act as a flywheel device and to cause a rotational movement of the wheel. The non-compressible fluid is transferred between the cylinders in the two semi-circular parts of the wheel alternately to generate an imbalance in the weight of the two semicircular parts of the wheel thereby converting a gravitational energy due to the imbalance of weight of the two semi-circular parts of the wheel into a rotational movement of the wheel.

According to an embodiment herein, the guiding path is designed such that a radius of guiding path arranged in a left side of the wheel is different from radius of the guiding path in a right side to cause a piston movement.

According to an embodiment herein, the radius of the guiding path in the right side of the wheel is less than the radius of the guiding path in the left side of the wheel so that the pistons connected to the guiding path in the right side of the wheel are moved down to receive the non-compressible fluid in the folding bag coupled to the pistons connected to the guiding path in the right side of the wheel while the pistons connected to the guiding path in the left side of wheel are moved up to empty the fluid from the folding bag connected to the pistons coupled to the left side of the wheel thereby enabling a fluid transfer between the folding bags arranged in the left side of the wheel and the folding bags arranged in the left side of the wheel to cause a rotation of the wheel.

According to an embodiment herein, a cross-sectional area of the guiding path provided at the left side of the wheel is different from a cross-sectional area of the guiding path provided at the right side of the wheel sides of the wheel.

According to an embodiment herein, a length of the cylinders and pistons is greater than a width of the cylinders and pistons.

According to an embodiment herein, the plurality of cylinders and pistons are designed such that the cylinders are not connected to the pistons to reduce friction.

According to an embodiment herein, the non-compressible fluid is not stored in the cylinders and pistons directly used as containers for fluid to prevent a reduction in an output of the system due to friction.

According to an embodiment herein, the non-compressible fluid is transferred in steps to provide a step-by-step motion of the wheel to increase an output of the system.

According to an embodiment herein, the non-compressible fluid is selected from a group consisting of water, oil and mercury.

According to an embodiment herein, the piston path reader is configured to move in the guiding path to determine a position of the pistons in the plurality of cylinders.

According to an embodiment herein, the piston path reader is a ball bearing.

According to an embodiment herein, each folding bag is configured to expand and fold depending on an amount of fluid in the folding bag.

According to an embodiment herein, each folding bag is pushed by a movement of the piston to a fully opened condition or a partially compressed condition or a fully compressed condition.

According to an embodiment herein, one end of the piston is connected to the guide path and another end of the piston is connected to the folding bag.

According to an embodiment herein, the piston path reader is provided at the end of the piston connected to the guiding path.

According to an embodiment herein, wherein a cross-sectional area of the connecting pipes is reduced to increase the pressure exerted by the non-compressible fluid.

According to an embodiment herein, the non-compressible liquid moves in an upward direction thereby causing an instability in the weight of the wheel and resulting in the continuous motion of the wheel.

According to an embodiment herein, the cross-sectional area of the connecting pipes is designed to be very less so that the pressure exerted by the non-compressible fluid is higher.

According to an embodiment herein, a system for converting gravity into a continuous rotational motion in a wheel is provided. The system comprises a wheel, in which weight of the wheel is not divided symmetrically between the two sides. The wheel is configured to change position to achieve stability. A plurality of cylinders and pistons are arranged on the periphery of the wheel. A plurality of cylinders and pistons are positioned at equal intervals on the wheel. A plurality of connecting pipes and a hose are provided to establish a pathway for flow of fluids. The fluid is an incompressible fluid. The incompressible fluid is passed through the connecting pipes and a hose. A folding bag is provided in each cylinder. The folding bags arranged in the cylinders, which are arranged mutually opposite to one another, are connected to a respective connecting pipe to provide a flow path for the incompressible liquid resulting in a motion of the wheel. Each folding bag is configured to expand and fold depending on the amount of fluid in the folding bag.

According to an embodiment herein, a system for converting gravity to a continuous rotational motion in a wheel is provided. The dimensions of the wheel are changed based on a requirement or application. The weight of the wheel is distributed in such a way that the weight loads on the two sides of the wheel are not equal or the weight loads on the two sides of the wheel are unbalanced thereby causing a continuous motion of the wheel.

According to an embodiment herein, the plurality of cylinders and pistons are designed such that there is no contact between cylinders and pistons thereby reducing/minimizing friction. The cylinders and pistons are not directly configured/designed for use as containers for fluid, as the cylinders and pistons are sealed to reduce the output of the system due to friction.

According to an embodiment herein, each folding bag in the system is connected to the folding bag situated diagonally opposite in the wheel. The fluid in the folding bag is transferred to the diagonally situated folding bag in an upward direction, and wherein the motion of the fluid causes an instability/imbalance in the weight of the wheel and results in the continuous motion of the wheel.

According to an embodiment herein, the motion of an incompressible fluid provides a step-by-step motion of the wheel. The step-by-step motion improves the output of the system.

According to an embodiment herein, the incompressible liquid moves in an upward direction and causes an instability in the weight of the wheel, which results in the continuous motion of the wheel.

According to an embodiment herein, the area of the connecting pipes is designed to be very less so that the pressure exerted by the incompressible fluid is higher.

According to an embodiment herein, the length of the cylinders and pistons is greater than the width of the cylinders and pistons.

According to an embodiment herein, the system comprises cylinders, pistons, connection pipes, wheel, guiding path, piston's path readers, an axis of rotation, ball bearing, folding bag, rotational motion transfer device, chassis, fixed cap and stand.

According to an embodiment herein, each cylinder and piston arrangement in the wheel comprises a folding bag, which holds an incompressible fluid. The fluid flows from one folding bag to another, which is located diagonally opposite, through the connection pipes.

According to an embodiment herein, the weight of the wheel is not uniform due to the incompressible fluid present in the folding bags to the right side of the axis of the wheel. The imbalance in weight causes the rotation motion of the wheel.

According to an embodiment herein, the cylinders are placed at equal distances from each other along the periphery of the wheel.

According to an embodiment herein, the folding bag is kept in three operating conditions. The three operation conditions include a fully opened or uncompressed condition, a partially pressed condition and a fully compressed condition.

According to an embodiment herein, the folding bags are placed inside the cylinders of the wheel.

According to an embodiment herein, an arrangement of connecting pipes and hoses that transfer the incompressible fluid from one folding bag to another folding bag arranged in an opposite side is provided. The connecting pipes are provided to connect a diagonally opposite pair of folding bags to move/pass the incompressible liquid.

According to an embodiment herein, the folding bag is compressed by the piston.

According to an embodiment herein, a system for converting gravity to a continuous rotational motion in a wheel is provided. The rotational motion of a wheel is sustained when an imbalance in the weight on the two sides of the wheel is maintained. The unbalanced weight distribution of is achieved through the flow of an incompressible liquid in the wheel. According to Pascal's law, a pressure change occurring anywhere in a confined incompressible fluid is transmitted throughout the fluid such that the same change occurs everywhere. According to the law, the pressures P1 and P2 exerted by an incompressible fluid in a confined space of transmission pipes in the two weights unbalanced sides of the wheel are equal. When n is the number of cylinders in the wheel and are filled fully with the fluids, F1 is the total weight of the fluid, F2 is the weight of water inside the transmission pipes, A1 is the area of the cylinders, A2 is the area of the transmission pipes, H1 is the height of cylinders, H2 is the height of the wheel and r is the radius of the wheel, then the Pascal's law for the rotational wheel is given as:

P1=P2

F1/A1=F2/A2

The centre of gravity in the bow of semicircle is two times the radius of the wheel divided by pi, which is 0.65 times the radius of the wheel. Substituting the values in the equation gives:

(n×A1×H1×0.65×r)/A1=(A2×H2)/A2

H2=n×0.65×H1×r

Accordingly the wheel does not rotate as the fluid does not transfer from the lower cylinder to the higher cylinder, When H2=n×0.65×H1. When H2<n×0.65×H1, the wheel works as the fluid transfers from the lower cylinder to higher cylinder.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a front view of a system to convert gravity into continuous rotational motion of a wheel through incompressible liquids, according to an embodiment herein.

FIG. 2 illustrates a side view of a pair of diagonally opposite pistons and cylinders of a system to convert gravity into continuous rotational motion of a wheel through incompressible liquids in a system to convert gravity into continuous rotational motion of a wheel through incompressible liquids, according to an embodiment herein.

FIG. 3 illustrates the front view of the frame of the wheel with slots for cylinders in a system to convert gravity into continuous rotational motion of a wheel through incompressible liquids, according to an embodiment herein.

FIG. 4 illustrates a front view of the frame assembly arranged cylinders, folding bags in a wheel and the rotational motion of the wheel in a system to convert gravity into continuous rotational motion of a wheel through incompressible liquids, according to an embodiment herein.

FIG. 5 illustrates a front view of the frame assembly arranged with cylinders, and folding bags arranged with fully compressed, partially compressed and fully opened conditions in a system to convert gravity into continuous rotational motion of a wheel through incompressible liquids, according to an embodiment herein.

FIG. 6 illustrates a front view of the frame assembly arranged with cylinders, and folding bags indicating an imbalance in the distribution of weight in the wheel due to the fully compressed, partially compressed and fully opened conditions of folding bag in a system to convert gravity into continuous rotational motion of a wheel through incompressible liquids, according to an embodiment herein.

FIG. 7A illustrates a folding bag in a full open condition, according to an embodiment herein.

FIG. 7B illustrates a folding bag in a partially compressed condition, according to an embodiment herein.

FIG. 7C illustrates a folding bag in a completely compressed condition, according to an embodiment herein.

FIG. 8A illustrates a fully opened folding bag with a piston, according to an embodiment herein.

FIG. 8B illustrates a partially compressed folding with a piston, according to an embodiment herein.

FIG. 8C illustrates a completely compressed folding bag with a piston, according to an embodiment herein.

FIG. 9 illustrates a front view of an arrangement of connecting pipes and hoses configured for transferring the incompressible fluid from one folding bag to another folding bag in the opposite side in a system to convert gravity into continuous rotational motion of a wheel through incompressible liquids, according to an embodiment herein.

FIG. 10 illustrates a schematic representation of a path of the machine on a fixed chassis in a system to convert gravity into continuous rotational motion of a wheel through incompressible liquids, according to an embodiment herein.

Although the specific features of the embodiments herein are shown in some drawings and not in others. This is done for convenience only as each feature may be combined with any or all of the other features in accordance with the embodiment herein.

### DETAILED DESCRIPTION OF THE EMBODIMENTS HEREIN

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a system and a method to convert gravitational energy into continuous rotational energy and movement of a wheel through incompressible liquids.

According to an embodiment herein, a system for converting gravity to a continuous rotational motion in a wheel is provided. The system comprises a wheel provided with a wheel frame. The wheel is divided into two semi-circular parts. The wheel is designed such that a weight of the wheel is not divided symmetrically between the two semicircular parts. A plurality of cylinders and pistons are provided on the wheel frame. The plurality of cylinders and pistons are arranged and equally spaced on the wheel frame. Each piston is connected to a guiding path. A folding bag is provided on each cylinder in the plurality of cylinders. Each folding bag is filled with a non-compressible fluid. Each folding bag comprises bellows to enable an expansion and contraction of the folding bag. Each folding bag is connected to the piston in the cylinder. A plurality of connecting pipes or hoses are arranged for providing a pathway for a flow of non-compressible fluid between the folding bags arranged diagonally opposite to each other. Each one of the plurality connecting pipes or hoses is connected between the two cylinders that are arranged mutually opposite to each other on the wheel frame to provide a pathway for a movement of the non-compressible fluid. A chassis is provided for supporting the wheel. The wheel is mounted on the chassis through a ball bearing mechanism. The plurality of pistons are connected to the chassis through a piston path reader. A stationary cap is arranged outside the wheel frame and coupled to the chassis to hold the wheel in place. An axle is passed through a rotational axis of the wheel. The axle is coupled to the chassis and the stationary cap. A energy transfer mechanism is coupled to the axle to transfer an output rotational energy. The energy transfer mechanism is a pulley. The non-compressible fluid in the plurality of cylinders provided in one semicircular part of the wheel is emptied by the movement of the pistons and the non-compressible fluid is transferred to the plurality of cylinders in the other semicircular part of the wheel thereby generating an imbalance in weight of the two semicircular parts of the wheel to make the wheel to act as a flywheel device and to cause a rotational movement of the wheel. The non-compressible fluid is transferred between the cylinders in the two semi-circular parts of the wheel alternately to generate an imbalance in the weight of the two semicircular parts of the wheel thereby converting a gravitational energy due to the imbalance of weight of the two semi-circular parts of the wheel into a rotational movement of the wheel.

According to an embodiment herein, the guiding path is designed such that a radius of guiding path arranged in a left side of the wheel is different from radius of the guiding path in a right side to cause a piston movement.

According to an embodiment herein, the radius of the guiding path in the right side of the wheel is less than the radius of the guiding path in the left side of the wheel so that the pistons connected to the guiding path in the right side of the wheel are moved down to receive the non-compressible fluid in the folding bag coupled to the pistons connected to the guiding path in the right side of the wheel while the pistons connected to the guiding path in the left side of wheel are moved up to empty the fluid from the folding bag connected to the pistons coupled to the left side of the wheel thereby enabling a fluid transfer between the folding bags arranged in the left side of the wheel and the folding bags arranged in the left side of the wheel to cause a rotation of the wheel.

According to an embodiment herein, a cross-sectional area of the guiding path provided at the left side of the wheel is different from a cross-sectional area of the guiding path provided at the right side of the wheel sides of the wheel.

According to an embodiment herein, a length of the cylinders and pistons is greater than a width of the cylinders and pistons.

According to an embodiment herein, the plurality of cylinders and pistons are designed such that the cylinders are not connected to the pistons to reduce friction.

According to an embodiment herein, the non-compressible fluid is not stored in the cylinders and pistons directly used as containers for fluid to prevent a reduction in an output of the system due to friction.

According to an embodiment herein, the non-compressible fluid is transferred in steps to provide a step-by-step motion of the wheel to increase an output of the system.

According to an embodiment herein, the non-compressible fluid is selected from a group consisting of water, oil and mercury.

According to an embodiment herein, the piston path reader is configured to move in the guiding path to determine a position of the pistons in the plurality of cylinders.

According to an embodiment herein, the piston path reader is a ball bearing.

According to an embodiment herein, each folding bag is configured to expand and fold depending on an amount of fluid in the folding bag.

According to an embodiment herein, each folding bag is pushed by a movement of the piston to a fully opened condition or a partially compressed condition or a fully compressed condition.

According to an embodiment herein, one end of the piston is connected to the guide path and another end of the piston is connected to the folding bag.

According to an embodiment herein, the piston path reader is provided at the end of the piston connected to the guiding path.

According to an embodiment herein, wherein a cross-sectional area of the connecting pipes is reduced to increase the pressure exerted by the non-compressible fluid.

According to an embodiment herein, the non-compressible liquid moves in an upward direction thereby causing an instability in the weight of the wheel and resulting in the continuous motion of the wheel.

According to an embodiment herein, the cross-sectional area of the connecting pipes is designed to be very less so that the pressure exerted by the non-compressible fluid is higher.

According to an embodiment herein, a system for converting gravity into a continuous rotational motion in a wheel is provided. The system comprises a wheel, in which weight of the wheel is not divided symmetrically between the two sides. The wheel is configured to change position to achieve stability. A plurality of cylinders and pistons are arranged on the periphery of the wheel. A plurality of cylinders and pistons are positioned at equal intervals on the wheel. A plurality of connecting pipes and a hose are provided to establish a pathway for flow of fluids. The fluid is an incompressible fluid. The incompressible fluid is passed through the connecting pipes and a hose. A folding bag is provided in each cylinder. The folding bags arranged in the cylinders, which are arranged mutually opposite to one another, are connected to a respective connecting pipe to provide a flow path for the incompressible liquid resulting in a motion of the wheel. Each folding bag is configured to expand and fold depending on the amount of fluid in the folding bag.

According to an embodiment herein, a system for converting gravity to a continuous rotational motion in a wheel is provided. The dimensions of the wheel are changed based on a requirement or application. The weight of the wheel is distributed in such a way that the weight loads on the two sides of the wheel are not equal or the weight loads on the two sides of the wheel are unbalanced thereby causing a continuous motion of the wheel.

According to an embodiment herein, the plurality of cylinders and pistons are designed such that there is no contact between cylinders and pistons thereby reducing/minimizing friction. The cylinders and pistons are not directly configured/designed for use as containers for fluid, as the cylinders and pistons are sealed to reduce the output of the system due to friction.

According to an embodiment herein, each folding bag in the system is connected to the folding bag situated diagonally opposite in the wheel. The fluid in the folding bag is transferred to the diagonally situated folding bag in an upward direction, and wherein the motion of the fluid causes an instability/imbalance in the weight of the wheel and results in the continuous motion of the wheel.

According to an embodiment herein, the motion of an incompressible fluid provides a step-by-step motion of the wheel. The step-by-step motion improves the output of the system.

According to an embodiment herein, the incompressible liquid moves in an upward direction and causes an instability in the weight of the wheel, which results in the continuous motion of the wheel.

According to an embodiment herein, the area of the connecting pipes is designed to be very less so that the pressure exerted by the incompressible fluid is higher.

According to an embodiment herein, the length of the cylinders and pistons is greater than the width of the cylinders and pistons.

According to an embodiment herein, the system comprises cylinders, pistons, connection pipes, wheel, guiding path, piston's path readers, an axis of rotation, ball bearing, folding bag, rotational motion transfer device, chassis, fixed cap and stand.

According to an embodiment herein, each cylinder and piston arrangement in the wheel comprises a folding bag, which holds an incompressible fluid. The fluid flows from one folding bag to another, which is located diagonally opposite, through the connection pipes.

According to an embodiment herein, the weight of the wheel is not uniform due to the incompressible fluid present in the folding bags to the right side of the axis of the wheel. The imbalance in weight causes the rotation motion of the wheel.

According to an embodiment herein, the cylinders are placed at equal distances from each other along the periphery of the wheel.

According to an embodiment herein, the folding bag is kept in three operating conditions. The three operation conditions include a fully opened or uncompressed condition, a partially pressed condition and a fully compressed condition.

According to an embodiment herein, the folding bags are placed inside the cylinders of the wheel.

According to an embodiment herein, an arrangement of connecting pipes and hoses that transfer the incompressible fluid from one folding bag to another folding bag arranged in an opposite side is provided. The connecting pipes are provided to connect a diagonally opposite pair of folding bags to move/pass the incompressible liquid.

According to an embodiment herein, the folding bag is compressed by the piston.

According to an embodiment herein, a system for converting gravity to a continuous rotational motion in a wheel is provided. The rotational motion of a wheel is sustained when an imbalance in the weight on the two sides of the wheel is maintained. The unbalanced weight distribution of is achieved through the flow of an incompressible liquid in the wheel. According to Pascal's law, a pressure change occurring anywhere in a confined incompressible fluid is transmitted throughout the fluid such that the same change occurs everywhere. According to the law, the pressures P1 and P2 exerted by an incompressible fluid in a confined space of transmission pipes in the two weights unbalanced sides of the wheel are equal. When n is the number of cylinders in the wheel and are filled fully with the fluids, F1 is the total weight of the fluid, F2 is the weight of water inside the transmission pipes, A1 is the area of the cylinders, A2 is the area of the transmission pipes, H1 is the height of cylinders, H2 is the height of the wheel and r is the radius of the wheel, then the Pascal's law for the rotational wheel is given as:

P1=P2

F1/A1=F2/A2

The centre of gravity in the bow of semicircle is two times the radius of the wheel divided by pi, which is 0.65 times the radius of the wheel. Substituting the values in the equation gives:

(n×A1×H1×0.65×r)/A1=(A2×H2)/A2

H2=n×0.65×H1×r

Accordingly the wheel does not rotate as the fluid does not transfer from the lower cylinder to the higher cylinder, When H2=n×0.65×H1. When H2<n×0.65×H1, the wheel works as the fluid transfers from the lower cylinder to higher cylinder.

According to an embodiment herein, each folding bag in the system is connected to the folding bag situated diagonally opposite in the wheel. The fluid in the bags is transferred to the diagonally situated folding bag in an upward direction, and wherein the motion of the fluid causes an instability in the weight of the wheel and results in the continuous motion of the wheel.

According to an embodiment herein, the motion of an incompressible fluid provides a step-by-step motion of the wheel. The step-by-step motion improves the output of the system.

According to an embodiment herein, the incompressible liquid moves in an upward direction and causes an instability in the weight of the wheel, which results in the continuous motion of the wheel.

According to an embodiment herein, the area of the connecting pipes is designed to be very less so that the pressure exerted by the incompressible fluid is higher.

According to an embodiment herein, the length of the cylinders and pistons is greater than the width of the cylinders and pistons.

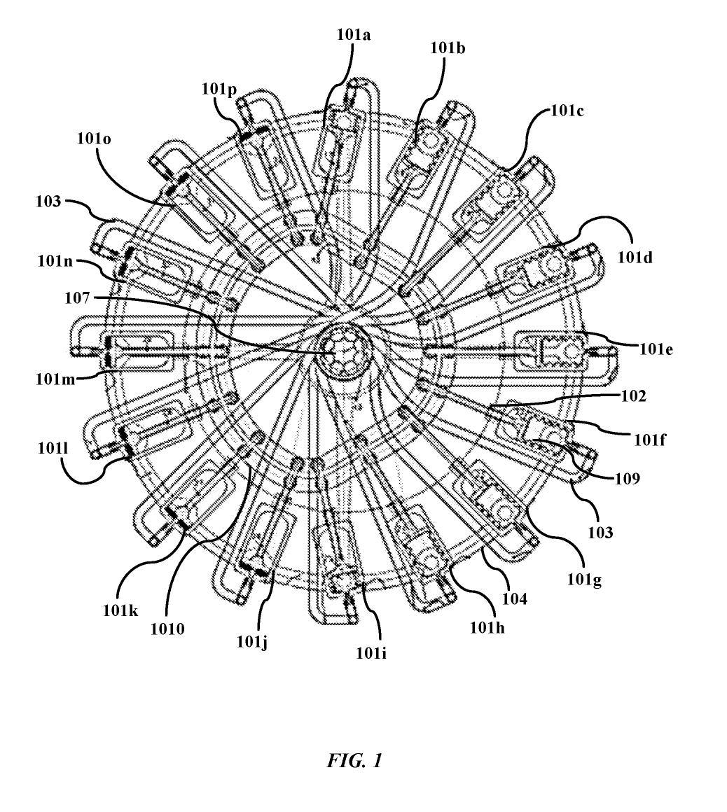

FIG. 1 illustrates a front view of a system to convert gravity into continuous rotational motion of a wheel through incompressible liquids, according to an embodiment herein. Each cylinder 101a-101p and piston 102 arrangement in the wheel 104 comprises a folding bag 109, which holds the incompressible fluid. The fluid flows from one folding bag 109 to another, which is located diagonally opposite, through the connection pipes 103.

The system comprises a wheel 104 provided with a wheel frame. The wheel 104 is divided into two semi-circular parts. The wheel 104 is designed such that a weight of the wheel is not divided symmetrically between the two semicircular parts. A plurality of cylinders 101a-101p and pistons 102 are provided on the wheel frame. The plurality of cylinders 101a-101p and pistons 102 are arranged and equally spaced on the wheel frame. Each piston 102 is connected to a guiding path 1010. A folding bag 109 is provided on each cylinder 102 in the plurality of cylinders. Each folding bag 109 is filled with a non-compressible fluid. Each folding bag 109 comprises bellows to enable an expansion and contraction of the folding bag 109. Each folding bag 109 is connected to the piston 102 in the cylinder 101a-101p. A plurality of connecting pipes or hoses 103 are arranged for providing a pathway for a flow of non-compressible fluid between the folding bags 109 arranged diagonally opposite to each other. Each one of the plurality connecting pipes or hoses 103 is connected between the two cylinders 102 that are arranged mutually opposite to each other on the wheel frame to provide a pathway for a movement of the non-compressible fluid. A chassis is provided for supporting the wheel. The wheel is mounted on the chassis through a ball bearing mechanism. The plurality of pistons 102 are connected to the chassis through a piston path reader. A stationary cap is arranged outside the wheel frame and coupled to the chassis to hold the wheel in place. An axle is passed through a rotational axis of the wheel. The axle is coupled to the chassis and the stationary cap. An energy transfer mechanism is coupled to the axle to transfer an output rotational energy. The energy transfer mechanism is a pulley. The non-compressible fluid in the plurality of cylinders provided in one semicircular part of the wheel is emptied by the movement of the pistons and the non-compressible fluid is transferred to the plurality of cylinders in the other semicircular part of the wheel thereby generating an imbalance in weight of the two semicircular parts of the wheel to make the wheel to act as a flywheel device and to cause a rotational movement of the wheel. The non-compressible fluid is transferred between the cylinders in the two semi-circular parts of the wheel alternately to generate an imbalance in the weight of the two semicircular parts of the wheel thereby converting a gravitational energy due to the imbalance of weight of the two semi-circular parts of the wheel into a rotational movement of the wheel.

According to an embodiment herein, the guiding path is designed such that a radius of guiding path arranged in a left side of the wheel is different from radius of the guiding path in a right side to cause a piston movement.

According to an embodiment herein, the radius of the guiding path in the right side of the wheel is less than the radius of the guiding path in the left side of the wheel so that the pistons connected to the guiding path in the right side of the wheel are moved down to receive the non-compressible fluid in the folding bag coupled to the pistons connected to the guiding path in the right side of the wheel while the pistons connected to the guiding path in the left side of wheel are moved up to empty the fluid from the folding bag connected to the pistons coupled to the left side of the wheel thereby enabling a fluid transfer between the folding bags arranged in the left side of the wheel and the folding bags arranged in the left side of the wheel to cause a rotation of the wheel.

According to an embodiment herein, a cross-sectional area of the guiding path provided at the left side of the wheel is different from a cross-sectional area of the guiding path provided at the right side of the wheel sides of the wheel.

According to an embodiment herein, a length of the cylinders and pistons is greater than a width of the cylinders and pistons.

According to an embodiment herein, the plurality of cylinders and pistons are designed such that the cylinders are not connected to the pistons to reduce friction.

According to an embodiment herein, the non-compressible fluid is not stored in the cylinders and pistons directly used as containers for fluid to prevent a reduction in an output of the system due to friction.

According to an embodiment herein, the non-compressible fluid is transferred in steps to provide a step-by-step motion of the wheel to increase an output of the system.

According to an embodiment herein, the non-compressible fluid is selected from a group consisting of water, oil and mercury.

According to an embodiment herein, the piston path reader is configured to move in the guiding path to determine a position of the pistons in the plurality of cylinders.

According to an embodiment herein, the piston path reader is a ball bearing.

According to an embodiment herein, each folding bag is configured to expand and fold depending on an amount of fluid in the folding bag.

According to an embodiment herein, each folding bag is pushed by a movement of the piston to a fully opened condition or a partially compressed condition or a fully compressed condition.

According to an embodiment herein, one end of the piston is connected to the guide path and another end of the piston is connected to the folding bag.

According to an embodiment herein, the piston path reader is provided at the end of the piston connected to the guiding path.

According to an embodiment herein, wherein a cross-sectional area of the connecting pipes is reduced to increase the pressure exerted by the non-compressible fluid.

According to an embodiment herein, the non-compressible liquid moves in an upward direction thereby causing an instability in the weight of the wheel and resulting in the continuous motion of the wheel.

According to an embodiment herein, the cross-sectional area of the connecting pipes is designed to be very less so that the pressure exerted by the non-compressible fluid is higher.

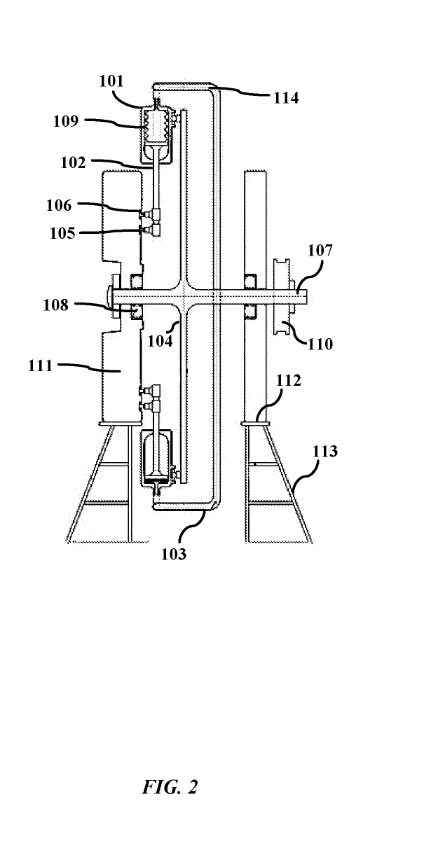

FIG. 2 illustrates a side view of a pair of diagonally opposite pistons and cylinders of a system to convert gravity into continuous rotational motion of a wheel through incompressible liquids, according to an embodiment herein. The system comprises cylinders 101a-10p, pistons 102, connection pipes 103, wheel 104, guiding path 105, piston's path readers 106, axis of rotation 107, ball bearing 108, folding bag 109, rotational motion transfer device 110, chassis 111, fixed cap 112 and stand 113.

With respect to FIG. 2, the system for converting gravity to a continuous rotational motion in a wheel is provided. The system comprises a wheel 104 provided with a wheel frame. The wheel is divided into two semi-circular parts. The wheel is designed such that a weight of the wheel is not divided symmetrically between the two semicircular parts. A plurality of cylinders 101a-101p and pistons 102 are provided on the wheel frame. The plurality of cylinders 101a-101p and pistons 102 are arranged and equally spaced on the wheel frame. Each piston 101a-101p is connected to a guiding path. A folding bag 109 is provided on each cylinder 101a-101p in the plurality of cylinders 101a-101p. Each folding bag 109 is filled with a non-compressible fluid 114. Each folding bag 109 comprises bellows to enable an expansion and contraction of the folding bag 109. Each folding bag 109 is connected to the piston 102 in the cylinder 101. A plurality of connecting pipes or hoses 103 are arranged for providing a pathway for a flow of non-compressible fluid 114 between the folding bags 109 arranged diagonally opposite to each other. Each one of the plurality connecting pipes or hoses 103 is connected between the two cylinders 101 that are arranged mutually opposite to each other on the wheel frame to provide a pathway for a movement of the non-compressible fluid. A chassis is provided for supporting the wheel 104. The wheel 104 is mounted on the chassis 111 through a ball bearing mechanism 108. The plurality of pistons 102 are connected to the chassis 111 through a piston path reader 106. A stationary cap 112 is arranged outside the wheel frame and coupled to the chassis 111 to hold the wheel 104 in place. An axle 107 is passed through a rotational axis of the wheel. The axle 107 is coupled to the chassis 111 and the stationary cap 112. An energy transfer mechanism 110 is coupled to the axle 107 to transfer an output rotational energy. The energy transfer mechanism is a pulley. The non-compressible fluid in the plurality of cylinders provided in one semicircular part of the wheel is emptied by the movement of the pistons and the non-compressible fluid is transferred to the plurality of cylinders in the other semicircular part of the wheel thereby generating an imbalance in weight of the two semicircular parts of the wheel to make the wheel to act as a flywheel device and to cause a rotational movement of the wheel. The non-compressible fluid is transferred between the cylinders in the two semi-circular parts of the wheel alternately to generate an imbalance in the weight of the two semicircular parts of the wheel thereby converting a gravitational energy due to the imbalance of weight of the two semi-circular parts of the wheel into a rotational movement of the wheel.

According to an embodiment herein, a length of the cylinders and pistons is greater than a width of the cylinders and pistons.

According to an embodiment herein, the plurality of cylinders and pistons are designed such that the cylinders are not connected to the pistons to reduce friction.

According to an embodiment herein, the non-compressible fluid is not stored in the cylinders and pistons directly used as containers for fluid to prevent a reduction in an output of the system due to friction.

According to an embodiment herein, the non-compressible fluid is transferred in steps to provide a step-by-step motion of the wheel to increase an output of the system.

According to an embodiment herein, the non-compressible fluid is selected from a group consisting of water, oil and mercury.

According to an embodiment herein, the piston path reader is configured to move in the guiding path to determine a position of the pistons in the plurality of cylinders.

According to an embodiment herein, the piston path reader is a ball bearing.

According to an embodiment herein, each folding bag is configured to expand and fold depending on an amount of fluid in the folding bag.

According to an embodiment herein, each folding bag is pushed by a movement of the piston to a fully opened condition or a partially compressed condition or a fully compressed condition.

According to an embodiment herein, one end of the piston is connected to the guide path and another end of the piston is connected to the folding bag.

According to an embodiment herein, the piston path reader is provided at the end of the piston connected to the guiding path.

According to an embodiment herein, wherein a cross-sectional area of the connecting pipes is reduced to increase the pressure exerted by the non-compressible fluid.

According to an embodiment herein, the non-compressible liquid moves in an upward direction thereby causing an instability in the weight of the wheel and resulting in the continuous motion of the wheel.

According to an embodiment herein, the cross-sectional area of the connecting pipes is designed to be very less so that the pressure exerted by the non-compressible fluid is higher.

According to an embodiment herein, some cylinders 101a-101p are embedded on a wheel 104 radially so an imaginary line is formed between the cylinders to cross the wheel's center. A folding bag 109 is provided in each cylinder 101a-101p provided with a folding bag 109 filled with the liquid which is available through pipes 103. The pistons 102 in the cylinders 101a-101p are connected to guiding path of pistons path on one side and connected to the folding bag 109 on the other side that has a cross section as big as the liquid container which is put under pressure. The principle or mechanism involved behind the gravity, instability and the tendency for stability are explained as follows. A plurality of the cylinders 101a-101h are in a low position because of the position of the respective pistons 102. So the resulted volume in the container embedded between cylinders and pistons, which are surrounded by the folding bag, is at the highest degree. A non-compressible fluid (liquid) such as water, oil or mercury is used to fill the folding bags in the cylinders.

All the embedded cylinders on the wheel which rotate around the center thereby resulting in a flywheel which has tendency to rotate clockwise. The guiding path causes the flywheel.

The path is designed in a way that in right side the radius is smaller, so the pistons are lead to their lowest position and the weight between cylinder and piston is on the highest degree. All the cylinders on the right side of the wheel are filled by the fluid so the flywheel is made. On the other side of the wheel (left side), the guiding path's radius is bigger which leads the pistons to their highest degree and empty the cylinders that make this side lighter than the other side. The difference between guiding path's radius' equals to pistons' movement.

The lowest part of the path where the smaller radius is getting bigger is the exact place where pistons get to their highest position from their lowest position, which makes the fluid replacement in the connection pipes. As a result, the lower container becomes empty and transfers its weight to a container which is the container in the highest place.

Due to the presence of same fluid in the cylinders that are arranged diagonally opposite to each other, the pistons' path readers are configured to move in the guiding path which determines the position of pistons in cylinders. with respect to the guiding path and the position of piston, the cylinder is compressed due to clockwise rotation of the wheel and the piston in guiding path, and because of usage of the non-compressible fluid in the container, thereby resulting in the transfer of fluid. This transfer of fluid movement in pipe or in the connection pipes results in changing the cylinder into closed condition. As a result, the cylinders arranged diagonally opposite to each other forms a closed system through the connection pipe. Similarly the diagonally arranged pair of the cylinders and the connecting pipe arranged between the cylinders form a closed system for a fluid transfer.

Hence the liquid in one cylinder is transferred to the diagonally opposite cylinder through a connection pipe in a closed system under pressure. Then one cylinder in the closed system is emptied to become lighter while the diagonally opposite cylinder in the closed system is filled with fluid and becomes heavy thereby resulting in the rotation of the wheel. Thus the movement of the fluid between the diagonally opposite cylinders result in a continuous motion of the wheel. By using non-compressible fluids and earth gravity, a rotational movement of the wheel is achieved in many fields such as motion, electricity and etc.

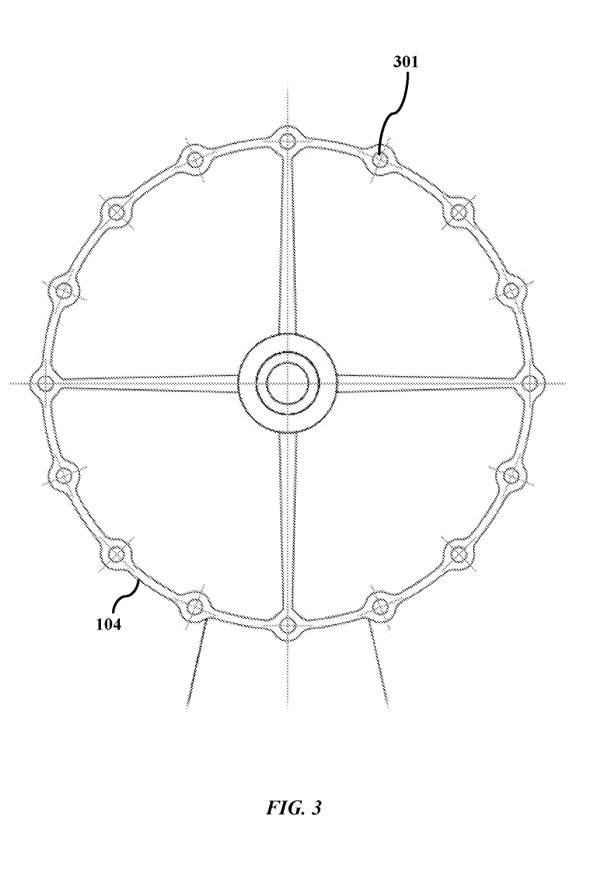

FIG. 3 illustrates the front view of the frame of the wheel with slots for cylinders in a system to convert gravity into continuous rotational motion of a wheel through incompressible liquids, according to an embodiment herein. The cylinder slots 301 are placed at equal distances from each other along the wheel 104 for receiving the cylinders. A plurality of cylinders and pistons are provided on slots at the wheel frame. The plurality of cylinders and pistons are arranged and equally spaced on the wheel frame.

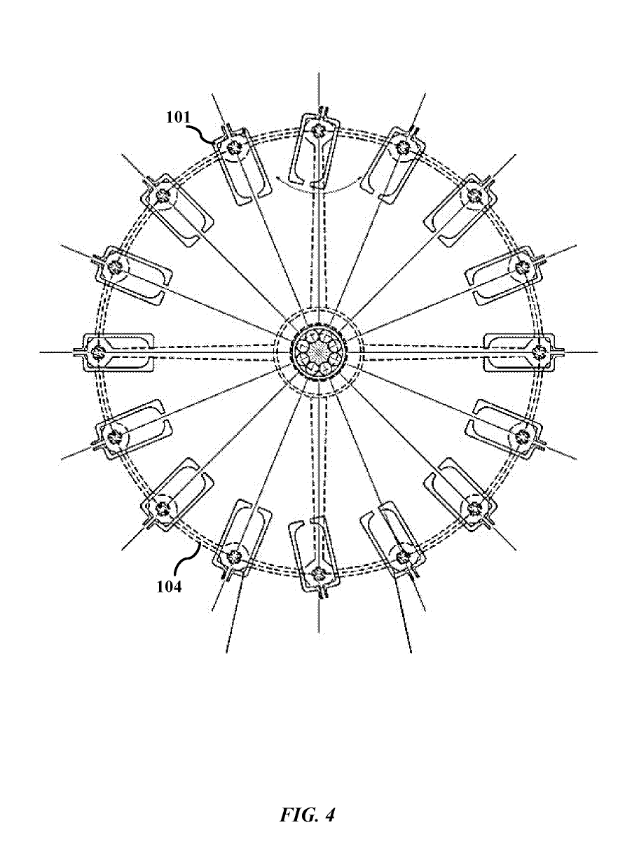

FIG. 4 illustrates a front view of the frame assembly arranged cylinders, folding bags in a wheel and the rotational motion of the wheel in a system to convert gravity into continuous rotational motion of a wheel through incompressible liquids, according to an embodiment herein. The cylinders 101a-101p are placed at equal distances from each other along the wheel 104. A plurality of cylinders 101a-101p and pistons are provided on the wheel frame. The plurality of cylinders 101a-101p and pistons are arranged and equally spaced on the wheel frame. Each piston is connected to a guiding path. A folding bag is provided on each cylinder 101a-10p in the plurality of cylinders 101a-101p. Each folding bag is filled with a non-compressible fluid. Each folding bag comprises bellows to enable an expansion and contraction of the folding bag 109.

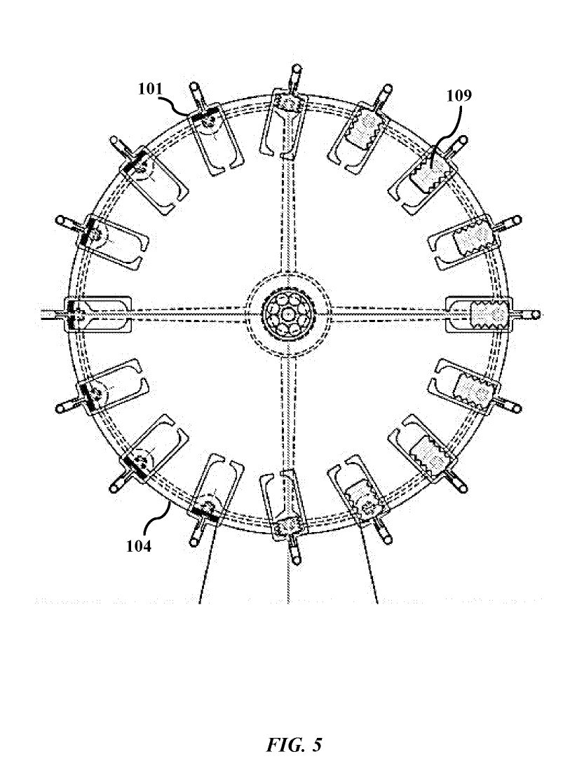

FIG. 5 illustrates a front view of the frame assembly arranged with cylinders, and folding bags arranged with fully compressed, partially compressed and fully opened conditions in a system to convert gravity into continuous rotational motion of a wheel through incompressible liquids, according to an embodiment herein. The folding bags 109 are placed inside the cylinders 101a-101p of the wheel 104. The weight of the wheel 104 is not uniform due to the incompressible fluid present in the folding bags 109 to the right side of the axis of the wheel 104. The imbalance in weight causes the rotation motion of the wheel 104.

The non-compressible fluid in the plurality of cylinders provided in one semicircular part of the wheel is emptied by the movement of the pistons and the non-compressible fluid is transferred to the plurality of cylinders in the other semicircular part of the wheel thereby generating an imbalance in weight of the two semicircular parts of the wheel to make the wheel to act as a flywheel device and to cause a rotational movement of the wheel. The non-compressible fluid is transferred between the cylinders in the two semi-circular parts of the wheel alternately to generate an imbalance in the weight of the two semicircular parts of the wheel thereby converting a gravitational energy due to the imbalance of weight of the two semi-circular parts of the wheel into a rotational movement of the wheel.

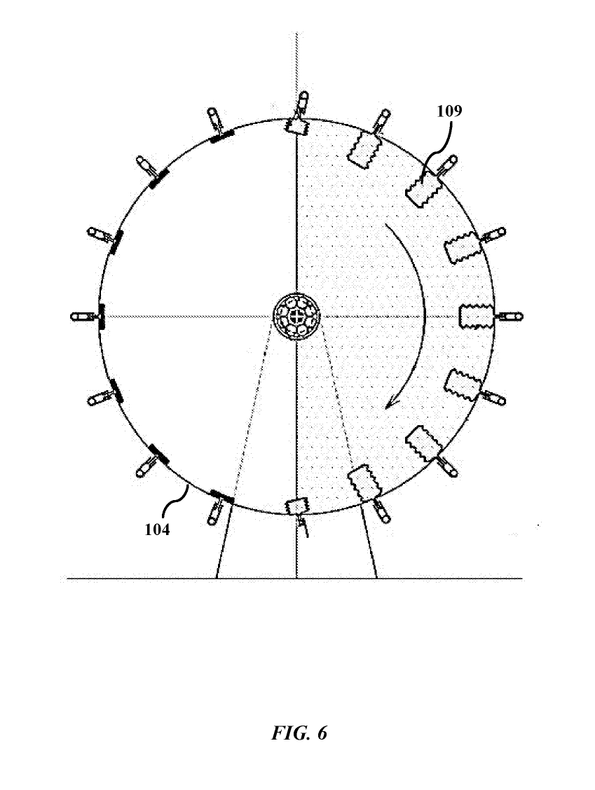

FIG. 6 illustrates a front view of the frame assembly arranged with cylinders, and folding bags indicating an imbalance in the distribution of weight in the wheel due to the fully compressed, partially compressed and fully opened conditions of folding bag in a system to convert gravity into continuous rotational motion of a wheel through incompressible liquids, according to an embodiment herein. The weight of the wheel 104 is not uniform due to the incompressible fluid present in the folding bags 109 to the right side of the axis of the wheel 104. The imbalance in weight causes the rotation motion of the wheel 104.

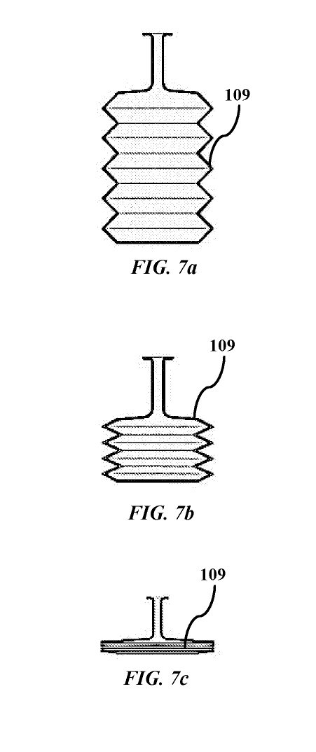

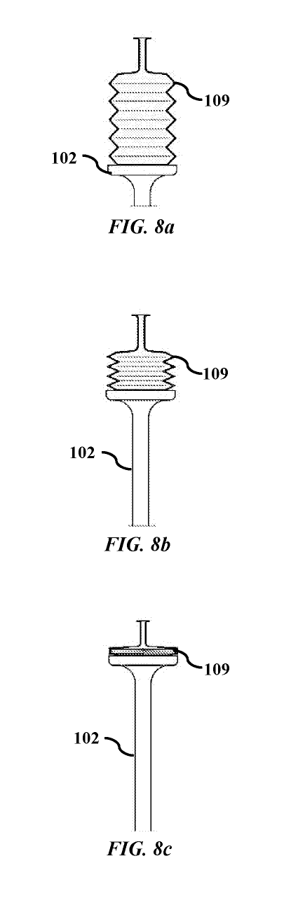

FIG. 7A illustrates a folding bag in a full open condition, according to an embodiment herein. FIG. 7B illustrates a folding bag in a partially compressed condition, according to an embodiment herein. FIG. 7C illustrates a folding bag in a completely compressed condition, according to an embodiment herein. FIG. 8A illustrates a fully opened folding bag with a piston, according to an embodiment herein. FIG. 8B illustrates a partially compressed folding with a piston, according to an embodiment herein. FIG. 8C illustrates a completely compressed folding bag with a piston, according to an embodiment herein.

With respect to FIGS. 7A-7C and FIGS. 8A-8C, the folding bags are used as a container instead of using cylinders and pistons because sealing off the cylinders and pistons puts lots of friction on the whole system and reduces the output. So the cylinders and pistons are designed in a way in which they have no contact and so no friction is produced.

Each cylinder is provided with a folding bag which is filled with the liquid and is available through pipes. Besides there are pistons in cylinders that are connected to folding bag. The folding bag 109 is compressed by the piston 102. The compression of folding bag is mainly due to the change in level of liquid in the folding bag, according to an embodiment herein. Each folding bag is pushed by a movement of the piston to a fully opened condition or a partially compressed condition or a fully compressed condition. Each folding bag is configured to expand and fold depending on an amount of fluid in the folding bag.

The non-compressible fluid in the plurality of cylinders provided in one semicircular part of the wheel is emptied by the movement of the pistons and the non-compressible fluid is transferred to the plurality of cylinders in the other semicircular part of the wheel thereby generating an imbalance in weight of the two semicircular parts of the wheel to make the wheel to act as a flywheel device and to cause a rotational movement of the wheel. The non-compressible fluid is transferred between the cylinders in the two semi-circular parts of the wheel alternately to generate an imbalance in the weight of the two semicircular parts of the wheel thereby converting a gravitational energy due to the imbalance of weight of the two semi-circular parts of the wheel into a rotational movement of the wheel.

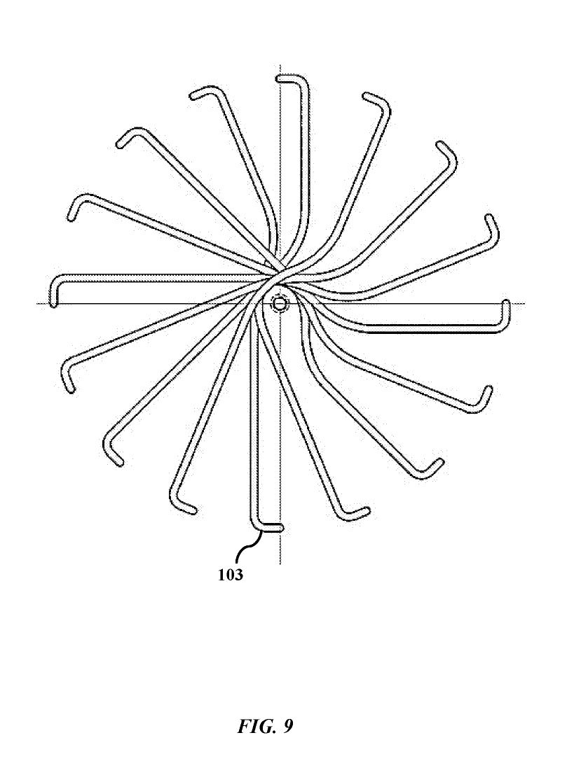

FIG. 9 illustrates a front view of an arrangement of connecting pipes 103 and hoses configured for transferring the incompressible fluid from one folding bag to another folding bag in the opposite side in a system to convert gravity into continuous rotational motion of a wheel through incompressible liquids, according to an embodiment herein. The connecting pipes 103 connect a diagonally opposite pair of folding bags, which are not shown in the figure, to enable the motion of incompressible liquid.

A plurality of connecting pipes or hoses 103 are arranged for providing a pathway for a flow of non-compressible fluid between the folding bags arranged diagonally opposite to each other. Each one of the plurality connecting pipes or hoses 103 is connected between the two cylinders that are arranged mutually opposite to each other on the wheel frame to provide a pathway for a movement of the non-compressible fluid.

According to an embodiment herein, wherein a cross-sectional area of the connecting pipes is reduced to increase the pressure exerted by the non-compressible fluid. According to an embodiment herein, the cross-sectional area of the connecting pipes is designed to be very less so that the pressure exerted by the non-compressible fluid is higher.

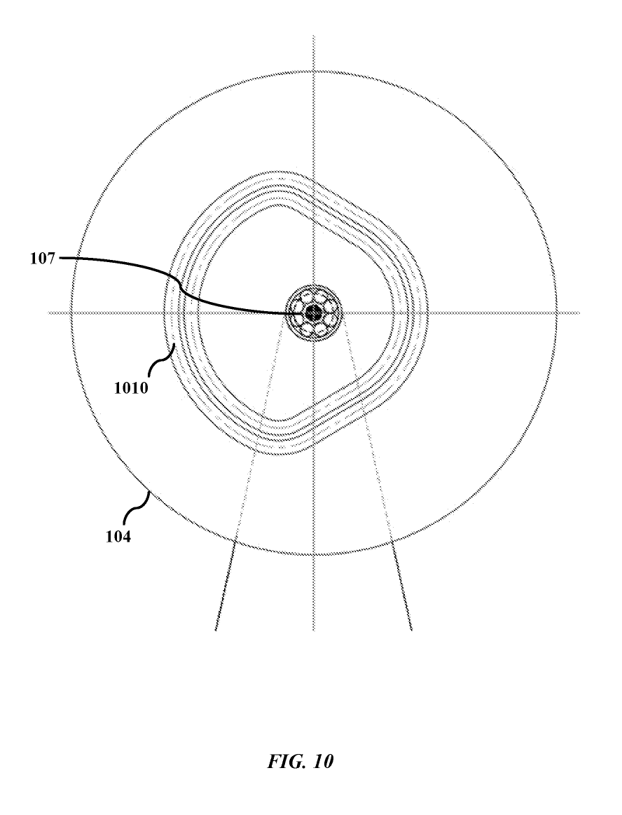

FIG. 10 illustrates a schematic representation of a path of the machine on a fixed chassis in a system to convert gravity into continuous rotational motion of a wheel through incompressible liquids, according to an embodiment herein. The path 1010 of the machine due to the rotation of the wheel 104 is irregular in shape. The guiding path is arranged around the axle 107.

According to an embodiment herein, the guiding path is designed such that a radius of guiding path arranged in a left side of the wheel is different from radius of the guiding path in a right side to cause a piston movement.

According to an embodiment herein, the radius of the guiding path in the right side of the wheel is less than the radius of the guiding path in the left side of the wheel so that the pistons connected to the guiding path in the right side of the wheel are moved down to receive the non-compressible fluid in the folding bag coupled to the pistons connected to the guiding path in the right side of the wheel while the pistons connected to the guiding path in the left side of wheel are moved up to empty the fluid from the folding bag connected to the pistons coupled to the left side of the wheel thereby enabling a fluid transfer between the folding bags arranged in the left side of the wheel and the folding bags arranged in the left side of the wheel to cause a rotation of the wheel.

According to an embodiment herein, a cross-sectional area of the guiding path provided at the left side of the wheel is different from a cross-sectional area of the guiding path provided at the right side of the wheel sides of the wheel.

According to an embodiment herein, one end of the piston is connected to the guide path and another end of the piston is connected to the folding bag.

According to an embodiment herein, the piston path reader is provided at the end of the piston connected to the guiding path. The piston path reader is a ball bearing.

The system introduces very less friction in the rotational motion of the wheel. The incompressible liquid used in the system distributes the weight of the wheel in an unbalanced manner so that the wheel rotates continuously and sustains the rotational motion. The motion of the wheel enables the working of a plurality of other devices that are connected to the wheel.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the appended claims.

It is also to be understood that the following claims are intended to cover all of the generic and specific features of the embodiments described herein and all the statements of the scope of the embodiments which as a matter of language might be said to fall there between.

What is claimed is:

1. A system for converting gravity to a continuous rotational motion in a wheel, the system comprising:
a wheel provided with a wheel frame, and wherein the wheel is divided into two semi-circular parts, and wherein the wheel is designed such that a weight of the wheel is not divided symmetrically between the two semicircular parts;
a plurality of cylinders and pistons provided on the wheel frame, wherein the plurality of cylinders and pistons are arranged and equally spaced on the wheel frame, and wherein each piston is connected to a guiding path;
a folding bag provided on each of the plurality of cylinders, and wherein each folding bag is filled with a non-compressible fluid, and wherein each folding bag comprises bellows to enable an expansion and contraction of the folding bag, and wherein each folding bag is connected to the piston in the cylinder;
a plurality of connecting pipes or hoses arranged for providing a pathway for a flow of non-compressible fluid between the folding bags arranged diagonally opposite to each other, and wherein each one of the plurality connecting pipes or hoses is connected between two cylinders that are arranged mutually opposite to each other on the wheel frame to provide a pathway for a movement of the non-compressible fluid;
a chassis for supporting the wheel, and wherein the wheel is mounted on the chassis through a ball bearing mechanism, and wherein the plurality of pistons are connected to the chassis through a piston path reader;
a stationary cap arranged outside the wheel frame and coupled to the chassis to hold the wheel in place;
an axle passed through a rotational axis of the wheel, and wherein the axle is coupled to the chassis and the stationary cap; and
an energy transfer mechanism coupled to the axle to transfer an output rotational energy, and wherein the energy transfer mechanism is a pulley;
wherein the non-compressible fluid in the plurality of cylinders provided in one semicircular part of the wheel is emptied by the movement of the pistons and the non-compressible fluid is transferred to the plurality of cylinders in the other semicircular part of the wheel thereby generating an imbalance in weight of the two semicircular parts of the wheel to make the wheel to act as a flywheel device and to cause a rotation of the wheel, and wherein the non-compressible fluid is transferred between the cylinders in the two semi-circular parts of the wheel alternately to generate an imbalance in the weight of the two semicircular parts of the wheel thereby converting a gravitational energy due to the imbalance of weight of the two semi-circular parts of the wheel into a rotational movement of the wheel.

2. The system according to claim 1, wherein the guiding path is designed such that a radius of guiding path arranged in a left side of the wheel is different from radius of the guiding path in a right side to cause a piston movement.

3. The system according to claim 1, wherein the radius of the guiding path in the right side of the wheel is less than the radius of the guiding path in the left side of the wheel so that the pistons connected to the guiding path in the right side of the wheel are moved down to receive the non-compressible fluid in the folding bag coupled to the pistons connected to the guiding path in the right side of the wheel while the pistons connected to the guiding path in the left side of wheel are moved up to empty the fluid from the folding bag connected to the pistons coupled to the left side of the wheel thereby enabling a fluid transfer between the folding bags arranged in the left side of the wheel and the folding bags arranged in the left side of the wheel to cause a rotation of the wheel.

4. The system according to claim 1, wherein a cross-sectional area of the guiding path provided at the left side of the wheel is different from a cross-sectional area of the guiding path provided at the right side of the wheel sides of the wheel.

5. The system according to claim 1, wherein a length of the cylinders and pistons is greater than a width of the cylinders and pistons.

6. The system according to claim 1, wherein the plurality of cylinders and pistons are designed such that the cylinders are not connected to the pistons to reduce friction.

7. The system according to claim 1, wherein the non-compressible fluid is not stored in the cylinders and pistons directly used as containers for fluid to prevent a reduction in an output of the system due to friction.

8. The system according to claim 1, wherein the non-compressible fluid is transferred in steps to provide a step-by-step motion of the wheel to increase an output of the system.

9. The system according to claim 1, wherein the non-compressible fluid is selected from a group consisting of water, oil and mercury.

10. The system according to claim 1, wherein the piston path reader is configured to move in the guiding path to determine a position of the pistons in the plurality of cylinders.

11. The system according to claim 1, wherein the piston path reader is a ball bearing.

12. The system according to claim 1, wherein each folding bag is configured to expand and fold depending on an amount of fluid in the folding bag.

13. The system according to claim 1, wherein each folding bag is pushed by a movement of the piston to a fully opened condition or a partially compressed condition or a fully compressed condition.

14. The system according to claim 1, wherein one end of the piston is connected to the guide path and another end of the piston is connected to the folding bag.

15. The system according to claim 1, wherein the piston path reader is provided at the end of the piston connected to the guiding path.

16. The system according to claim 1, wherein a cross-sectional area of the connecting pipes is reduced to increase the pressure exerted by the non-compressible fluid.
